(19) United States
(12) Patent Application Publication
(10) Pub. No.: US 2023/0214763 A1
(43) Pub. Date: Jul. 6, 2023

(54) METHOD AND SYSTEM FOR BUILDING OR OPTIMIZING A SUPPLY CHAIN

(71) Applicant: Golyath Inc, Miami, FL (US)

(72) Inventor: Baris Talaysum, Miami, FL (US)

(21) Appl. No.: 17/970,924

(22) Filed: Oct. 21, 2022

Related U.S. Application Data
(60) Provisional application No. 63/295,678, filed on Dec. 31, 2021.

(51) Int. Cl. G06Q 10/08; G06Q 10/06

(52) U.S. Cl. CPC G06Q 10/0838; G06Q 10/06395

(57) ABSTRACT

A system and method for building or optimizing a supply chain is presently provided. The method comprises registering and inputting provided services or capabilities by at least one supply chain service provider, registering and inputting desired services or desired capabilities by a supplier of goods, and selecting, or presenting to the supplier of goods for the selecting with the system, at least one of the registered supply chain service providers, by the supplier of goods or the system. Each of the selected supply chain service providers is not associated with the supplier of goods.

### CROSS REFERENCE TO RELATED APPLICATIONS

This application claims priority to U.S. provisional application No. 63/295,678, flied Dec. 31, 2021, the disclosure of which is hereby incorporated by reference in its entirety.

### FIELD OF INVENTION

The present invention relates to processes and systems for building or optimizing a supply chain, for example, building or optimizing a supply chain network or logistics network.

### BACKGROUND OF THE INVENTION

Currently, warehousing systems typically operate as a stand-alone system for one warehouse to administer and work within their warehouse environment. Many sellers, for example internet retailers, and other companies that provide goods to their customers often store products in an associated warehouse.

It may be desired for suppliers of goods, such as manufacturers, to find unassociated or independent warehouse services, and other supply chain service providers, for the storage and distribution of goods to customers via an electronic platform, offering a diverse range of providers.

### SUMMARY

In at least one embodiment of the present disclosure, a method of building or optimizing a supply chain is provided. The method comprising the steps of: registering and inputting provided services or capabilities by at least one supply chain service provider, with a system: registering and inputting desired services or desired capabilities by a supplier of goods, with the system: and selecting, or presenting to the supplier of goods for the selecting with the system, at least one of the registered supply chain service providers, by the supplier of goods or the system. Each of the selected supply chain service providers is not associated with the supplier of goods and the selecting, or the presenting to the supplier of goods for the selecting, is based upon the input of the at least one supply chain service provider and the input of the supplier of goods.

In at least one other embodiment of the present disclosure, a system for building or optimizing a supply chain is configured and disposed for performing the above method. The system comprises a platform having a processor to implement a supply chain optimizer; a first data store on the platform having the services or capabilities of the at least one supply chain service provider, as input by the supply chain service provider; and a second data store on the platform having the desired services or desired capabilities of the at least one supplier of goods, as input by the supplier of goods. Each of the at least one supply chain service providers having data stored in the first data store is unassociated with, and independent of, each of the at least one supplier of goods having data stored in the second data store. The supply chain optimizer is configured to perform a) through c), wherein a) through c) are: a) receive the provided services or capabilities from the at least one supply chain service provider and to store the received data in the first data store; b) receive the desired services or desired capabilities from the at least one supplier of goods and to store the received data in the second data store; and c) receive a selection by one of the suppliers of goods of at least one supply chain service provider.

In at least one further embodiment of the present disclosure, a system for building or optimizing a supply chain is provided. The system comprises a platform having a processor to implement a supply chain optimizer, a first data store having data comprising services or capabilities of at least one supply chain service provider, and a second data store having data comprising desired services or desired capabilities of at least one supplier of goods. Each of the at least one supply chain service providers having data stored in the first data store is unassociated with, and independent of, each of the at least one supplier of goods having data stored in the second data store. The supply chain optimizer is configured to perform a) through c), wherein a) through c) are: a) receive provided services or capabilities from at least one supply chain service provider and to store the received data in the first data store; b) receive desired services or desired capabilities from at least one supplier of goods and to store the received data in the second data store; and c) receive a selection by one of the suppliers of goods of at least one supply chain service provider.

### BRIEF DESCRIPTION OF THE DRAWINGS

The foregoing and other features of this disclosure will become more fully apparent from the following description and appended claims, taken in conjunction with the accompanying drawings and examples. Understanding that these drawings depict only several embodiments in accordance with the disclosure and are therefore, not to be considered limiting of its scope, the disclosure will be described with additional specificity and detail through use of the accompanying drawings.

The following figures, which are idealized, are not to scale and are intended to be merely illustrative of aspects of the present disclosure and non-limiting. In the drawings, like elements may be depicted by like reference numerals. The drawings are briefly described as follows:

FIG. 1 shows an illustrative schematic view of steps taken by a warehouse or supply chain service provider for registering with the presently disclosed system for building or optimizing a supply chain of the present disclosure;

FIG. 2 shows an illustrative schematic view of steps taken by a supplier of goods for registering and selecting a warehouse or service provider with the presently disclosed system for building or optimizing a supply chain of the present disclosure;

FIGS. 3a, and 3b show an illustrative schematic view of steps taken by a supplier and by a warehouse or service provider for with the presently disclosed system for building or optimizing a supply chain of the present disclosure; and

FIG. 4 shows an illustrative schematic view of the presently disclosed system for building or optimizing a supply chain of the present disclosure.

### DETAILED DESCRIPTION OF THE INVENTION

The presently disclosed system and method of building or optimizing a supply chain may provide for a supplier, such as a manufacturer, the ability to connect with external and independent warehouses. For example, independent warehouses and service providers may come together to form a fulfillment and warehouse service network. The presently disclosed system and method may provide for a network where resources may be shared and may provide connectivity for managing goods being supplied, stored, and sent to customers.

The presently disclosed method may create a community in the sense that if one needs space, transportation or other services, a warehouse owner, supplier, or service provider may solicit services from a network or platform. The system may also provide other aspects of warehouse management, such as inventory management, order and receipt management and billing management. For example, aspects of the present disclosure may provide a supplier or manufacturer with warehouse, /3PL, /4PL, or a service provider network. A fourth-party logistics (4PL) provider may act as an integrator that assembles the resources, planning capabilities, and technology of its own organization and other organizations to design, build, and run comprehensive supply chain solutions. A third-party logistics (3PL) service provider may target a single function while a 4PL may provide for management of the entire process. A 4PL may be thought as a general contractor that manages other 3PLs, truckers, forwarders, custom house agents, and others, essentially taking responsibility of a complete process for the customer. Aspects of the present disclosure may provide 4PL functionality.

In at least one embodiment of the present disclosure, a software platform is provided that connects a supplier, such as a manufacturer, to a multitude of third-party independent warehouse vendors. The system may allow the supplier to select one or more of a multitude of third party warehouse vendors. In at least one other embodiment, the software platform may allow the supplier to pay some or all of their selected third party warehouse vendors or service providers through a central server.

Aspects of the present disclosure provide for a platform for a supplier of goods, such as a manufacturer, to search for one or more unassociated warehouses or unassociated supply chain service provider. The unassociated warehouses or service providers are not connected in any streamlined way, to the supplier of goods or each other. Aspects of the present disclosure may provide for a system of inventory management providing for the managing of inventory across multiple unassociated warehouses or supply chain service providers.

Aspects of the present disclosure may provide a method, system, or software platform that may be capable of connecting a supplier of goods, such as a manufacturer, to a multitude of third-party independent warehouses and/or service providers. The system or platform may allow individual third party warehouse providers to opt in for selection by a supplier for providing services. For example, the system and method may allow the supplier to search and select one or more warehouses from a multitude of third-party warehouses. For example, a warehouse may register on an electronic platform and may be presented to unassociated suppliers. One or more suppliers may then select one or more unassociated warehouses for providing services to the unassociated suppliers. The presently disclosed system or software platform may allow the supplier to pay all, or some, of the selected multitude of third-party warehouses through the system. The presently disclosed system may further provide the supplier the ability to manage inventory of their goods, for some, or all, of the selected multitude of third-party warehouses through a server. Some third party warehouses may provide additional services such as labor and transportation.

In at least one embodiment, the present disclosure provides a system and method that allows supplier of goods to search and select one or more supply chain service providers from a multitude of third-party service providers. For example, a shipper or packager may register on an electronic platform and may be presented to unassociated suppliers. One or more suppliers may then select one or more unassociated supply chain service providers for providing services.

The system may be configured to select one or more warehouses and/or supply chain service providers for a supplier of goods. The selection may be made by the system based on the input by the supplier of goods and the warehouses and/or service providers. The selection of one or more warehouses and/or supply chain service providers may also be made with consideration of customer location and/or activity. For example, the system may be configured to store customer data, such as location, and this data may provide for a criteria that may be used in the selecting of unassociated warehouses or service providers. In at least one embodiment, the system may be configured to select and manage a pipeline of one or more warehouses, shippers, packagers, or other supply chain service providers to service the goods as they move from the supplier to the end customer. The supplier of goods is unassociated with each of the selected one or more warehouses, shippers, packagers, or other supply chain service providers. Each of the selected one or more warehouses, shippers, packagers, or other supply chain service providers are unassociated with each other.

In at least one embodiment of the present disclosure, a method of building or optimizing a supply chain comprises registering and inputting provided services or capabilities by at least one supply chain service provider, registering and inputting desired services or desired capabilities by a supplier of goods, selecting at least one of the registered unassociated supply chain service providers, each of the selected supply chain service providers is not associated with the supplier of goods, and the selecting is based upon the input of the at least one supply chain service provider and the input of the supplier of goods. The selecting may be performed by the system. The method may comprise a step of shipping goods from the supplier of goods to a first selected supply chain service provider and shipping at least a portion of the goods from the first selected supply chain service provider to a second selected supply chain service provider. The movement of the goods through the supply chain may be managed by the system and may utilize customer data in selecting service providers, such as customer location data.

In at least one embodiment of the present disclosure, a system for inventory management has a computer server that is capable of connecting a supplier to a multitude of independent third-party warehouse vendors that may be selectable by the supplier or by the system. The computer server or system may further provide the capability of allowing the supplier to pay selected third-party warehouse vendors through the computer server. The computer server may further provide the capability of allowing the supplier to manage an inventory with one, some, or all of the selected third-party warehouse vendors through the computer server.

In at least one other embodiment of the present disclosure, a method of building or optimizing a supply chain comprises registering and inputting provided services or capabilities, by at least one warehouse or at least one service provider, with a system configured to perform the method; registering and inputting desired warehouse services or capabilities or desired services, by a supplier, with the system; wherein each of the at least one warehouse or service provider is not associated with the supplier; selecting, or presenting to the supplier for the selecting, at least one warehouse or service provider, by the supplier or the system; wherein the selecting is based upon the input of the at least one warehouse or at least one service provider and the input of the supplier; shipping goods to the at least one selected warehouse or service provider, by the supplier; placing an order for the goods, by a customer; receiving the order placed by the customer, by the supplier or one of the at least one selected warehouses or service providers; and shipping the ordered goods from the warehouse or service provider to the customer.

As used herein, a supplier is an entity that supplies goods to a warehouse or a service provider in a supply chain. For example, a supplier may be a manufacturer, reseller, distributer, or any person or entity supplying a warehouse or service provider. A warehouse, as used herein, is any location or space where goods may be stored before their export or distribution for sale. A service provider, as used herein, is an entity in a supply chain that provides a service in relation to goods being moved from the source of goods or supplier to an end customer. The term service provider may include entities providing services and/or storage of goods in a chain of distribution from the supplier, or source of the goods, to the end customer. For example, the term service provider, as used herein, may include a packing company, shipper, or other service provider, that may receive goods during transport from a supplier to an end customer. In at least one embodiment, a warehouse in the distribution chain may store and process the goods for shipping to a customer.

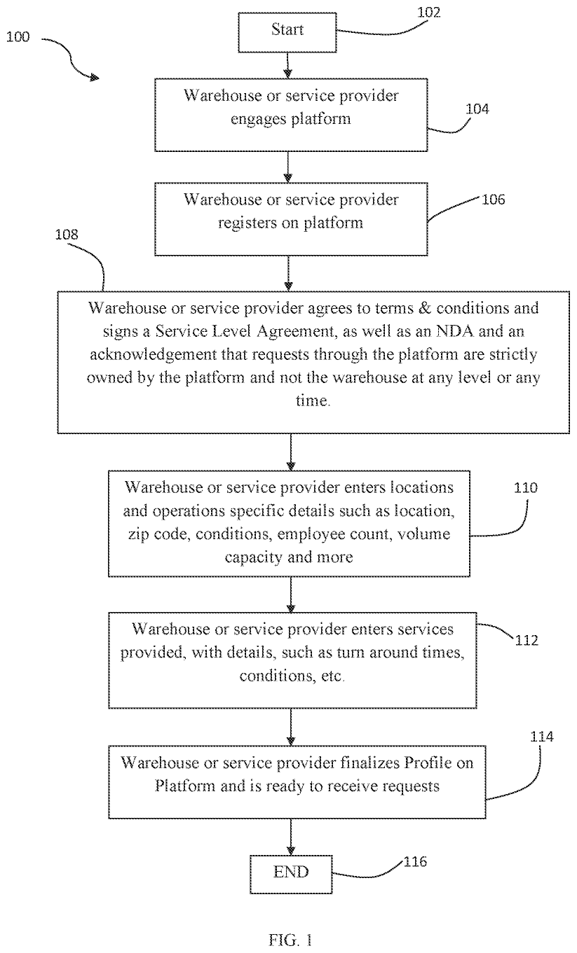

FIG. 1 shows an illustrative schematic view of method 100 having steps taken by a warehouse or supply chain service provider for registering with the presently disclosed system for building or optimizing a supply chain of the present disclosure. The process starts at step 102 and the warehouse or service provider engages with the system or platform at step 104 and registers at step 106. At step 108, the warehouse or service provider agrees to terms & conditions and signs a Service Level Agreement, as well as an NDA and an acknowledgement that requests made, or input of desired services, on the platform are strictly owned by the platform and not the warehouse or service provider at any level or any time.

The warehouse or service provider enters locations and operations, specific details such as location zip code, size, conditions, employee count, volume capacity and other relevant information at step 110. At step 112, the warehouse or service provider enters services provided, with details, such as turn around times, conditions, and any special services, for example. The warehouse or service provider finalizes their profile on the platform and indicates that they are ready to receive requests for service at step 114 and the registration process for the warehouse or service provider ends at step 116.

The system may be configured to establish central pricing. For example, the system may be configured to present pricing to the warehouses or service providers during registration. Alternatively, the warehouses or service providers may enter their own pricing,

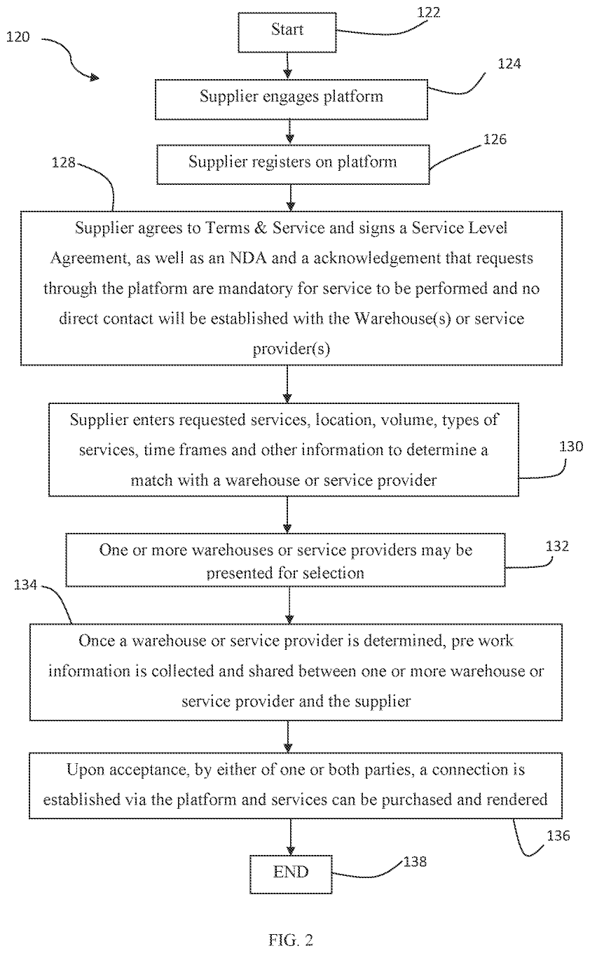

FIG. 2 shows an illustrative schematic view of method 120 having steps taken by a supplier of goods for registering and selecting a warehouse or service provider with the presently disclosed system for building or optimizing a supply chain of the present disclosure. The process starts at step 122 and the supplier of goods engages with the system or platform at step 124 and registers at step 126.

At step 128, the supplier agrees to terms & conditions and signs a Service Level Agreement, as well as an NDA and an acknowledgement that requests through the platform are mandatory for service to be performed and no direct contact will be established with the warehouses or service providers on the system. The supplier enters required services, locations, volume, time frames, and other information to determine a match with a warehouse or service provider at step 130. Upon the warehouse or service provider being determined or selected, pre-work information is collected and shared between one or more warehouses or service providers and the supplier at step 134. Upon acceptance by either of one or both parties, a connection is established via the platform and services may be purchased and rendered at step 136. The process ends at step 138.

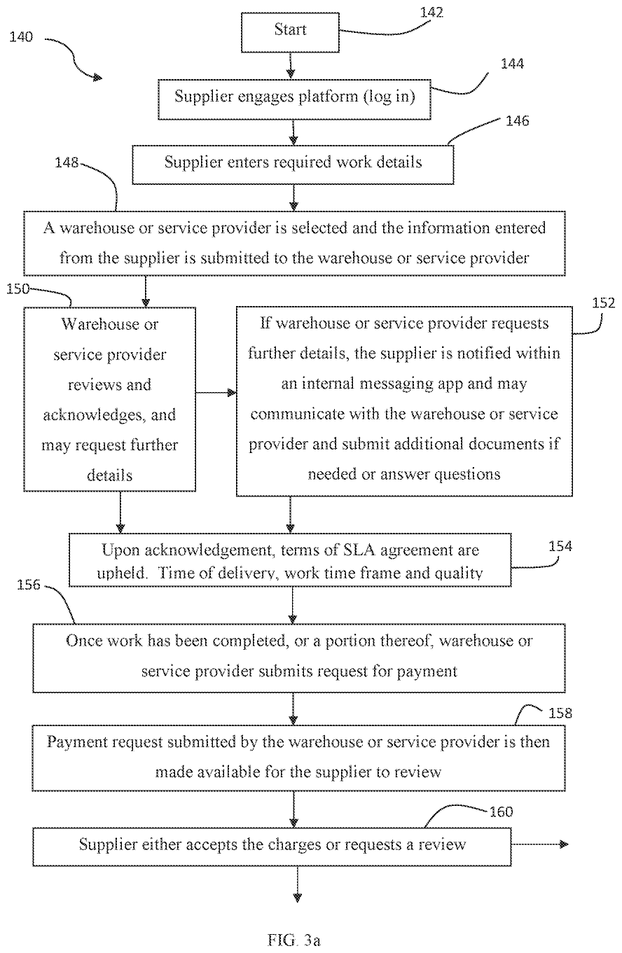

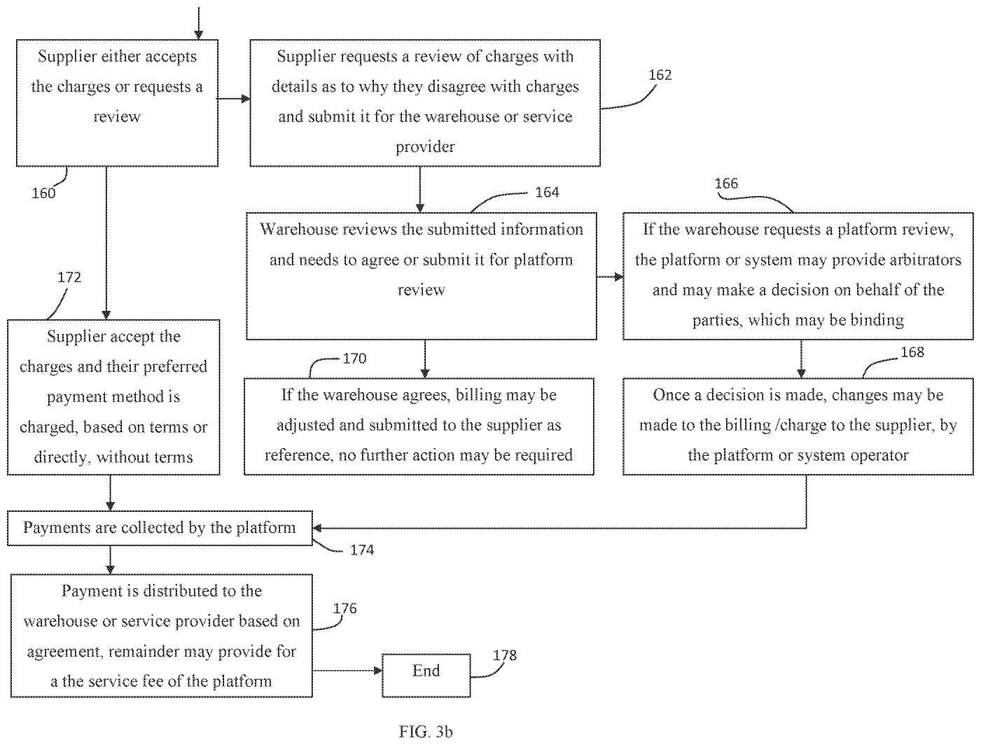

FIGS. 3a and 3b show an illustrative schematic view of process 140 and steps taken by a supplier and by a warehouse or service provider with the presently disclosed system for building or optimizing a supply chain of the present disclosure. The process starts at step 142 and the supplier of goods engages with the system or platform at step 144 and inputs desired services or required work details at step 146.

At step 148, a warehouse or service provider is selected, by the platform or by the supplier, and the information entered from the supplier is submitted to the warehouse or service provider. For example, the supplier of goods may select a warehouse or service provider, from a few prescreened warehouses or service providers for performing their required or desired services. Upon the selection being made, the information entered by the supplier is submitted to the selected warehouse or service provider. The warehouse or service provider reviews and acknowledges or asks for further details at step 150. If the warehouse or service provider asks for more information, the supplier is notified within an internal messaging app and may communicate with the warehouse or service provider and submit additional documents if needed or answer questions at step 152.

Upon acknowledgement, the terms of the SLA agreement are upheld, including time or delivery, work time frame, and quality at step 154. Once work has been completed or a portion therefore, the warehouse or service provider submits a request for payment at step 156. At step 158, the payment request submitted by the warehouse or service provider is then made available to the supplier to review. The supplier either accepts the charges or requests a review at step 160. The system may be configured to provide for an automatic acceptance after a set time period. For example, the system may accept the charges for the supplier after 2 business days, for example. At step 162, the supplier requests a review of charges with details as to why they disagree with charges and the request is submitted to the platform for the warehouse or service provider.

At step 164, the warehouse or service provider reviews the submitted information and agrees or submits it to the platform for platform review. If the Warehouse on service provider agrees, billing is adjusted and submitted to the supplier as reference, no further action may be required at step 170. If the warehouse or service provider requests a platform review, the information may be sent to an arbitrator for arbitration and a binding decision may be rendered on behalf of both parties at step 166. The arbitrator may be a third party arbitrator or may be associated with the system or platform. Once a decision is made, changes to billing/charge to the supplier may be made at step 168.

At step 172 the supplier accepts the charges and their preferred payment method is charged, based on terms or directly, without terms. Payments are collected by the platform at step 174 and payment is distributed to the warehouse or service provider based on agreement at step 176. The process ends at step 178.

In at least one embodiment of the present disclosure, a method of building or optimizing a supply chain comprises registering and inputting provided services or capabilities by at least one supply chain service provider, with a system; registering and inputting desired services or desired capabilities by a supplier of goods, with the system: and selecting, or presenting to the supplier of goods for the selecting with the system, at least one of the registered supply chain service providers, by the supplier of goods or the system. Each of the selected supply chain service providers is not associated with the supplier of goods. The selecting, or the presenting to the supplier of goods for the selecting, is based upon the input of the at least one supply chain service provider and the input of the supplier of goods.

The method may further comprise shipping goods from the supplier of goods to the selected supply chain service provider. An order for the goods shipped to the selected supply chain service provider may be placed by a customer. The ordered goods may be shipped from the selected supply chain service provider to the customer.

In at least one embodiment, the goods may be returned to the control of the supplier of goods, upon the selected supply chain service provider servicing the goods. An order placed by a customer may be received by the selected supply chain service provider, the supplier of goods, or the system. In at least one embodiment, the selected supply chain service provider is a warehouse and has input warehousing services or capabilities into the system.

Charges of the service provider may be calculated with the system and presented to the supplier of goods. The system may be configured to receive payments from the supplier of goods and to pay the service provider for the services rendered.

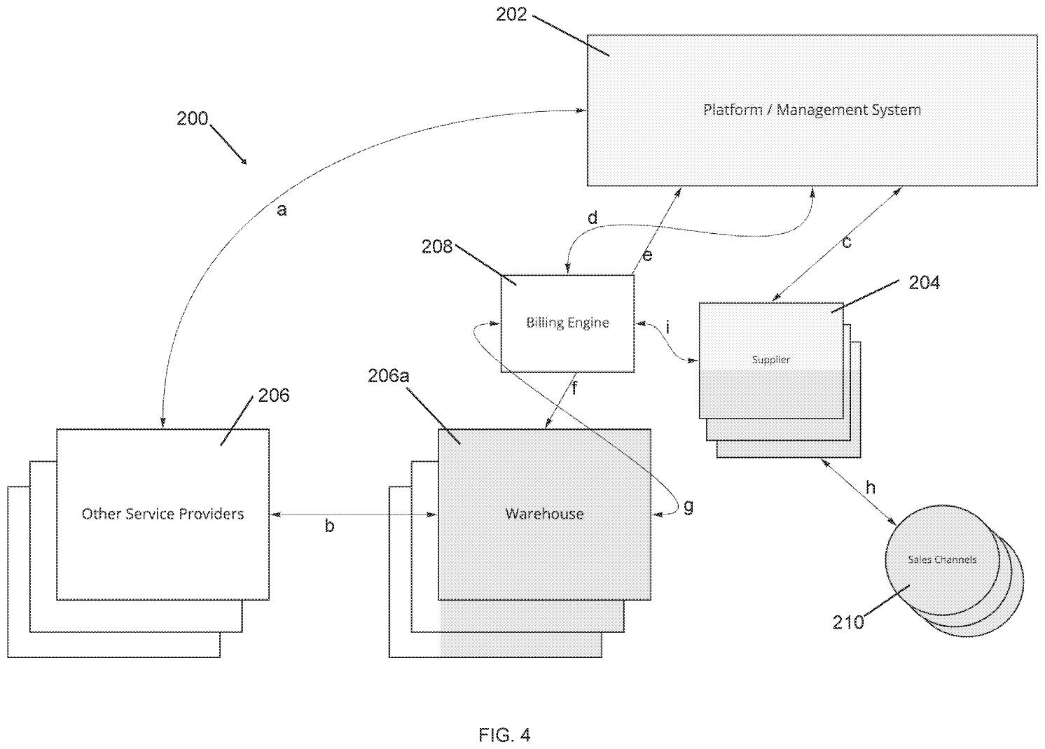

FIG. 4 shows an illustrative schematic view of system 200 for building or optimizing a supply chain. In at least one embodiment, system 200 is configured to perform the presently disclosed method, as disclosed above. For example, system 200 may have a platform 202 having a processor to implement a supply chain optimizer. A first data store, 206 and 206a, on the platform has the services or capabilities of at least one supply chain service provider, as input by the supply chain service provider. A second data store 204, on the platform has the desired services or desired capabilities of at least one supplier of goods, as input by the supplier of goods. Each of the at least one supply chain service providers having data stored in first data store 204 is unassociated with, and independent of, each of the at least one supplier of goods having data stored in the second data store 206 and 206a.

The supply chain optimizer is configured to receive the provided services or capabilities from the at least one supply chain service provider and to store the received data in the first data store; receive the desired services or desired capabilities from the at least one supplier of goods and to store the received data in the second data store; and receive a selection by one of the suppliers of goods of at least one supply chain service provider.

System 200 is void of a direct communications link between each of the at least one supply chain service provider and each of the at least one supplier of goods. This is shown in FIG. 4 wherein the first data store 204 and the second data store 206 and 206a have no communications link directly therebetween. The absence of this direct communications link provides for a continuation of the independence or lack of association of the supplier of goods and the service provider, at least until a selection is made by the supplier of goods.

The system of claim 14, wherein the platform is configured to compare the desired services or desired capabilities of one of the supplier of goods in the second data store with the provided services or capabilities from at least one supply chain service provider in the first data store and to present at least one of the supply chain service providers to the supplier of goods for the selection by the supplier of goods.

System 200 may have a billing engine 208 configured to calculate charges for the performance of services provided by the selected supply chain service provider and presenting the calculated charges to the supplier of goods, upon the performance of services provided by the selected supply chain service provider. In at least one embodiment, system 200 has sales channels 210 configured to receive an order placed by a customer for goods supplied by the suppliers of goods. System 200 may be configured to send the order received by the customer to the supply chain service provider servicing the goods for shipment of the ordered goods to the customer.

System 200 is configured for building or optimizing a supply chain and has platform 202 having a processor to implement a supply chain optimizer. A first data store, 206 and/or 206a, stores comprising services or capabilities of at least one supply chain service provider. A second data store 204 stores data comprising desired services or desired capabilities of at least one supplier of goods. Each of the at least one supply chain service provider has data stored in first data store 206 and/or 206a is unassociated with, and independent of, each of the at least one supplier of goods having data stored in the second data store 204. The supply chain optimizer resides on platform 202 and is configured to perform a) through c), wherein a) through c) are: a) receive provided services or capabilities from at least one supply chain service provider and to store the received data in the first data store; b) receive desired services or desired capabilities from at least one supplier of goods and to store the received data in the second data store; and c) receive a selection by one of the suppliers of goods of at least one supply chain service provider.

System 200 may have billing engine 208 configured to calculate charges for the performance of services provided by the selected supply chain service provider and presenting the calculated charges to the supplier of goods. Billing engine 208 may reside on platform 202 and, upon the performance of services provided by the selected supply chain service provider, may bill the supplier of goods.

System 200 may be configured to receive an order placed by a customer for goods supplied by the suppliers of goods. For example, system 200 may have sales channels 210 which may receive orders by customers and notify the supplier 204 via communications link h. System 200 may be configured to send the order received by the customer to the supply chain service provider servicing the goods for shipment of the ordered goods to the customer. For example the order received by the customer may be sent to platform 202, and to the service provider providing the service in first data store 206 and 206a, via links h, c, i, f, g, and/or a. Data link b may be configured to provide a link between data store 206 and 206a and configure them to be accessed as a single data store, for example first data store 206 and/or 206a. Data link d may link billing engine 208 with platform 202 to provide two way communication therebetween and data link e may link billing engine 208 with platform 202 to provide one way communication therebetween.

In at least one embodiment, customer data, such as goods purchased and location, is stored by the system. The system may be configured to select, or present a list for selection by the source of the goods, one or more warehouses or service providers based on the stored customer data. For example, the system may select warehouses that are nearest to the customers purchasing the goods, which may reduce shipping costs. The source of the goods may send a first portion of the goods to a first warehouse and a second portion of the goods to a second warehouse. A selected warehouse receiving the goods may send portion(s) of the received goods to one or more other warehouses, wherein each of the warehouses is unassociated with each other. For example, the system may be configured to provide a fulfillment/logistics network, wherein the warehouses on the platform as nodes. In at least one embodiment, the supplier of goods may ship their goods to the closest warehouse (node 1), selected by the system based on customer data. The node 1 warehouse may then distribute to other warehouses (nodes 2, 3, 4, etc.). The fulfillment/logistics network may by established and maneuvered by the platform/server with no or minimal input by the supplier of goods and the nodes may each be independent of one another.

### EXAMPLES

### Example 1

The method of optimizing a supply chain may begin with the registering with the system by one or more warehouses FIG. 1 shows steps that may be taken by a warehouse to register with the system. Upon registering, the warehouse is listed in a searchable database having their information such as location(s), operation specific details, location zip code, size, conditions, employee count, volume capacity, and/or other information that may be relevant for a supplier. The platform may not provide an open list that may be searched. For example, a supplier may enter specific information and the platform may screen and present the supplier with preferred warehouse options and may not present non-relevant warehouses & service providers to the supplier.

Information entered by a warehouse during registration may include, but not limited to, warehouse location (by zip code, for example), warehouse size (by sq ft, for example), quantity of docks & ramps, truck size limitations which may maneuver to the docks (20 ft, 40 ft, 53 ft, for example), yard availability, yard protection, site security, onsite cameras, client or supplier accessibility of camera footage, hours of operations, approximate count of employees, if the warehouse has a bonded area, if the warehouse can handle oversize pallets, a list of services provided (such as inbound/outbound, bundling/kitting, fulfillment, specialty services (such as bubble wrapping, gift wrapping, or other packaging services), temperatures (min/max), if the warehouse has cold storage, refrigerated storage, cold racks, if warehouse has RFID tracking capabilities, if warehouse has serial number and lot tracking capabilities, if warehouse has caged areas. Additional and other information may be added by a warehouse after registration and the information may be changed as warranted by the registered warehouse.

FIG. 2 shows that a supplier may register with the system and enter requested services, such as warehouse services. A supplier may input desired parameters such as location, volume, types of services, time frames, and/or other information for presentation on the platform and/or for selecting one or more warehouses from a database. For example, a supplier may be presented screened or preselected warehouses or service providers based on one or more of the parameters of the warehouses or service providers that were entered during registration. Upon a supplier entering information, the system may screen and present a list of warehouses, or otherwise present a list of warehouses, to the supplier for selecting or the system may be configured to select the warehouse(s) for the supplier. Upon the selection of one or more warehouses for or by the supplier, a connection may be established between the parties on the system and services may be purchased and rendered. The connection may be solely through the system or platform and no outside connection may be established. For example, the identity of the warehouse may not be given to the supplier and the identity of the supplier may not be given to the warehouse.

FIG. 3 shows an example of the flow of communication and cooperation between the warehouse and supplier on the presently disclosed system. In this example, a supplier enters desired services that are then forwarded to one or more selected warehouses. The warehouse reviews the supplier's desired services or request and may accept, upon which an SLA agreement may be established. Upon rendering services by the warehouse for the supplier, an invoice or request for payment may be generated by the platform or system or the invoice may be sent to the system by the warehouse. The system may send or forward a request for payment to the supplier, wherein the supplier may accept the charges or request a review of the charges made by the warehouse or system. Upon the supplier's acceptance of the charges for the warehouse's services, the supplier may pay the system or the entity operating the system or platform. The system may then pay the warehouse for services rendered to the supplier.

FIG. 4 shows an illustrative schematic view of the presently disclosed system for building or optimizing a supply chain of the present disclosure. In this illustrative example, a platform, system, management system, or engine is in communication with one or more warehouses and one or more suppliers. The system provides for the matching of warehouse(s) with supplier(s) based on services offered by the warehouse(s) and desired services requested by the supplier(s). The system may be configured to select, or match, warehouse(s) with supplier(s), or may be configured to assist a supplier in selecting warehouse(s), or to assist a warehouse in selecting supplier(s). Upon matching warehouse(s) with supplier(s), sales channels, such as online stores like eBay™, Amazon™, Shopify™, and the like may engage the supplier on behalf of a customer for the purchase of goods held by, or stored at, the warehouse. Upon a purchase being made by a customer, the system or platform will be notified of the purchase. The platform then relays the purchase order to the warehouse or service provider which in turn ships the purchased goods to the customer. The supplier may pay the platform for the services rendered by the warehouse and the platform may then pay the warehouse for their services.

The system may be configured to select, or provide platform enrollees for selection, based on criteria such as services provided and/or capabilities or services sought like warehouse size, shipping, climate control, capacity, access, returns, labeling, packaging, dispatching, staff, security, location, storage space, package size and weight capabilities, receiving process, picking process, quality control, delivery, management software, insurance, protection, transportation, loading, unloading, distributing, forwarding, repack, break down, rebuild, liquidation, handling, tracking, and other criteria that may be associated with a supplier, warehouse, or supply chain service provider.

In at least one aspect of the present disclosure, warehouses or service providers and suppliers may both register with the system and provide their information details. The supplier may enter their needs and the services they require. The supplier may add their work volume, how much product will be stored, shipped, or serviced, for example. This information may be presented to closely matching warehouses or service providers. For example, a supplier's request for services may be presented to a selected group of warehouses or service providers (the system may select the group using other criteria) and the warehouses or service providers in the selected group may bid for a contract/job for providing the services. The warehouse or service provider may have the opportunity to ask questions privately to the supplier to gauge their needs and their volume. Based on the bids received by the supplier, the supplier may award one or multiple warehouses and/or service providers the contract/job, or portions thereof.

It will be understood that the examples of patents, published patent applications, and other documents which are included below in this application and which are referred to in paragraphs which state “Some examples of . . . which may possibly be used in at least one possible embodiment of the present application . . . ” may possibly not be used or useable in any one or more embodiments of the application. These references, or portions thereof, are hereby incorporated by reference herein. The purpose of incorporating U.S. patents, foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

Some examples of features which may possibly be utilizable by at least one possible embodiment may possibly be found in the following which are incorporated by reference herein: U.S. Ser. No. 10/647,509B2, titled “SYSTEMS AND METHODS TO OUTSOURCE SERVICE AND SUPPORT OPERATIONS”, filed Apr. 19, 2017, by Lyon, Robert et al.; U.S. Pat. No. 8,285,609, titled “WAREHOUSE MANAGEMENT SYSTEM”, filed Apr. 7, 2010, by Pfeffer, David et al.; US20130218784A1, titled “4PL SYSTEM AND METHOD”, filed Apr. 2, 2013, by Alonzo, Bobbie Ann et al.; US20090307265, titled “METHOD OF OPERATING A WAREHOUSE”, filed Jun. 6, 2008, by Nicholson, Jerry Scott et al.; CN104463537A, titled “THIRD-PARTY LOGISTICS CLOUD WAREHOUSING SYSTEM”, filed 2014 Dec. 12, by PU ZHIQIANG et al.; and U.S. Pat. No. 7,788,145, titled “INTELLIGENT FULFILLMENT AGENTS”, filed Oct. 23, 2007, by Wadawadigi, Ganesh et al.

1. A method of building or optimizing a supply chain comprising the steps of:
registering and inputting provided services or capabilities by at least one supply chain service provider, with a system:
registering and inputting desired services or desired capabilities by a supplier of goods, with the system:
selecting, or presenting to the supplier of goods for the selecting with the system, at least one of the registered supply chain service providers, by the supplier of goods or the system;
wherein each of the selected supply chain service providers is not associated with the supplier of goods; and
wherein the selecting, or the presenting to the supplier of goods for the selecting, is based upon the input of the at least one supply chain service provider and the input of the supplier of goods.

2. The method of claim 1 further comprising a step of shipping goods from the supplier of goods to the selected supply chain service provider.

3. The method of claim 2 further comprising a step of placing an order for the goods shipped to the selected supply chain service provider, by a customer.

4. The method of claim 3 further comprising a step of shipping the ordered goods from the selected supply chain service provider to the customer.

5. The method of claim 2 further comprising a step of returning the goods by the selected supply chain service provider to the control of the supplier of goods, upon the selected supply chain service provider servicing the goods.

6. The method of claim 3, wherein the order placed by the customer is received by the selected supply chain service provider, the supplier of goods, or the system.

7. The method of claim 1, wherein the selected supply chain service provider is a warehouse and has input warehousing services or capabilities into the system.

8. The method of claim 1 further comprising a step of calculating charges of the service provider, with the system, and presenting the calculated charges to the supplier of goods.

9. The method of claim 8 further comprising a step of paying the system, by the supplier of goods, the calculated charges.

10. A system for building or optimizing a supply chain comprising:
a platform having a processor to implement a supply chain optimizer;
a first data store to store data comprising services or capabilities of at least one supply chain service provider;
a second data store to store data comprising desired services or desired capabilities of at least one supplier of goods;
each of the at least one supply chain service providers having data stored in the first data store is unassociated with, and independent of, each of the at least one supplier of goods having data stored in the second data store;
the supply chain optimizer is configured to perform a) through c), wherein a) through c) are:
a) receive provided services or capabilities from at least one supply chain service provider and to store the received data in the first data store;
b) receive desired services or desired capabilities from at least one supplier of goods and to store the received data in the second data store; and
c) receive a selection by one of the suppliers of goods of at least one supply chain service provider.

11. The system of claim 10 further comprising a billing engine, the billing engine being configured to calculate charges for the performance of services provided by the selected supply chain service provider and presenting the calculated charges to the supplier of goods, upon the performance of services provided by the selected supply chain service provider.

12. The system of claim 10 being configured to receive an order placed by a customer for goods supplied by the suppliers of goods.

13. The system of claim 12 being configured to send the order received by the customer to the supply chain service provider servicing the goods for shipment of the ordered goods to the customer.

14. A system for building or optimizing a supply chain configured and disposed for performing the method according to claim 1, the system comprising:
a platform having a processor to implement a supply chain optimizer;
a first data store on the platform having the services or capabilities of at the least one supply chain service provider, as input by the supply chain service provider;
a second data store on the platform having the desired services or desired capabilities of the at least one supplier of goods, as input by the supplier of goods;
wherein each of the at least one supply chain service providers having data stored in the first data store is unassociated with, and independent of, each of the at least one supplier of goods having data stored in the second data store;
the supply chain optimizer is configured to perform a) through c), wherein a) through c) are:
a) receive the provided services or capabilities from the at least one supply chain service provider and to store the received data in the first data store;
b) receive the desired services or desired capabilities from the at least one supplier of goods and to store the received data in the second data store; and
c) receive a selection by one of the suppliers of goods of at least one supply chain service provider.

15. The system of claim 14 being void of a direct communications link between each of the at least one supply chain service provider and each of the at least one supplier of goods.

16. The system of claim 14, wherein the platform is configured to compare the desired services or desired capabilities of one of the supplier of goods in the second data store with the provided services or capabilities from at least one supply chain service provider in the first data store and to present at least one of the supply chain service providers to the supplier of goods for the selection by the supplier of goods.

17. The system of claim 14 further comprising a billing engine, the billing engine being configured to calculate charges for the performance of services provided by the selected supply chain service provider and presenting the calculated charges to the supplier of goods, upon the performance of services provided by the selected supply chain service provider.

18. The system of claim 14 further comprising sales channels configured to receive an order placed by a customer for goods supplied by the suppliers of goods.

19. The system of claim 18 being configured to send the order received by the customer to the supply chain service provider servicing the goods for shipment of the ordered goods to the customer.

20. The method of claim 1, wherein the selecting is performed by the system.

21. The method of claim 20, further comprising a step of shipping goods from the supplier of goods to a first selected supply chain service provider and shipping at least a portion of the goods from the first selected supply chain service provider to a second selected supply chain service provider.
